(19) United States
(12) Patent Application Publication
(10) Pub. No.: US 2003/0006602 A1
(43) Pub. Date: Jan. 9, 2003

(54) Apparatus and method for retractable steering column

(76) Inventors: Bryan T. Waid, Kettering, OH (US); Craig M. Hanson, Kettering, OH (US); Allen R. Starner, Springboro, OH (US); James L. Webber, Shelby Township, MI (US); Andrew J. Piper, Warwickshire (GB)

Correspondence Address: Cantor Colburn LLP, Intellectual Property Attorneys, 55 Griffin Road South, Bloomfield, CT, 06002, US

(21) Appl. No.: 09/901,914

(22) Filed: Jul. 9, 2001

(51) Int. Cl. B62D 1/11

(52) U.S. Cl. 280/777; 280/775

(57) ABSTRACT

A retractable steering column is provided. The retractable steering column has a steering column and an outer tube. The outer tube has a first sealing member, and the steering column has a second sealing member. The steering column is sealed in the outer tube using the first and second sealing members. Thus, the first and second sealing members form a cavity between the steering column and the outer housing. The steering column is rotatable with respect to the outer tube and is slideable with respect to the outer tube from a first position to a second position. A gas generator generates a retraction pressure in the cavity to slide the steering column from the first position to the second position.

### TECHNICAL FIELD

This application relates generally to a retractable steering system. More specifically, this application relates to a steering column that actively retracts.

### BACKGROUND

Energy absorbing steering columns have been used in vehicles. Energy absorbing steering columns typically include a break away connection that allows the steering column to be repositioned.

Air bag modules have also been used in vehicles. An air bag module typically includes an inflatable cushion and an inflator for inflating the cushion. The cushion is stored in a folded position within the air bag module. A sensor is positioned to provide an activation signal which activates the inflator. The inflator or gas generator provides a supply of gas for inflating the cushion.

### SUMMARY

A retractable steering column, having an outer tube with a first sealing member and a second sealing member, a cavity is formed by sealing the steering column in the outer tube by the first sealing member and the second sealing member and a means for generating a retraction pressure in the cavity. The steering column is rotatable with respect to the outer tube and the steering column is positionable from a first position to a second position with respect to the outer tube upon the generation of the retraction pressure in the cavity.

A retractable steering system is provided for use with a vehicle having a steering box, a steering wheel and a means for generating an activation signal. The retractable steering system includes an outer tube having a first sealing member. The outer tube is securable to the vehicle. The retractable steering system also includes a steering column having a lower end, an upper end and a second sealing member. The lower end is securable to the steering box and the upper end is securable to the steering wheel. The second sealing member is disposed on the steering column between the lower end and the upper end. The first and second sealing members rotatably seal the steering column in the outer tube such that a cavity is formed. A gas generator generates a retraction pressure in the cavity in response to the activation signal. Thus, the steering column slides with respect to the outer tube from a first position to a second position upon the generation of the retraction pressure.

A retractable steering system is provided for use with a vehicle having a steering box, a steering wheel and a means for generating an activation signal. The retractable steering system includes an outer tube having a first sealing member and a first breakaway connection for securing the outer tube to the vehicle. The retractable steering system also includes an inner tube having a bearing member and a second sealing member. The first sealing member and the second sealing member slidably seal the inner tube in the outer tube to form a cavity. The retractable steering system also includes a steering column having a lower end securable to the steering box, an upper end securable to the steering wheel, and a second breakaway connection for securing the steering column to the vehicle. The inner tube's bearing member rotatably secures the steering column in the inner tube. A gas generator generates a retraction pressure in the cavity in response to the activation signal. Thus, the inner tube slides with respect to the outer tube from a first position to a second position upon the generation of the retraction pressure.

A method for automatically retracting a steering column in a vehicle is provided. The method includes initiating a signal from a sensor as a result of a pre-determined event; igniting a gas generator in response to the signal to generate a retracting pressure in a sealed cavity between the steering column and an outer tube; and sliding the steering column with respect to the outer tube from a first position to a second position in response to the retracting pressure acting on the steering column.

The above-described and other features and advantages of the present invention will be appreciated and understood by those skilled in the art from the following detailed description, drawings, and appended claims.

### BRIEF DESCRIPTION OF THE DRAWINGS

FIG. 1 is a side view of a retractable steering system for a vehicle;

FIG. 2 is a cross sectional view of a first exemplary embodiment of a retractable steering system in a first or use position;

FIG. 3 is a cross sectional view of the retractable steering system of FIG. 2 in a second or retracted position;

FIG. 4 is a cross sectional view of a second exemplary embodiment of a retractable steering system in a first or use position;

FIG. 5 is a cross sectional view of the retractable steering system of FIG. 4 in a second or retracted position;

FIG. 6 is a first exploded view of a break away connection; and

FIG. 7 is a second exploded view of a break away connection.

### DESCRIPTION OF THE PREFERRED EMBODIMENT

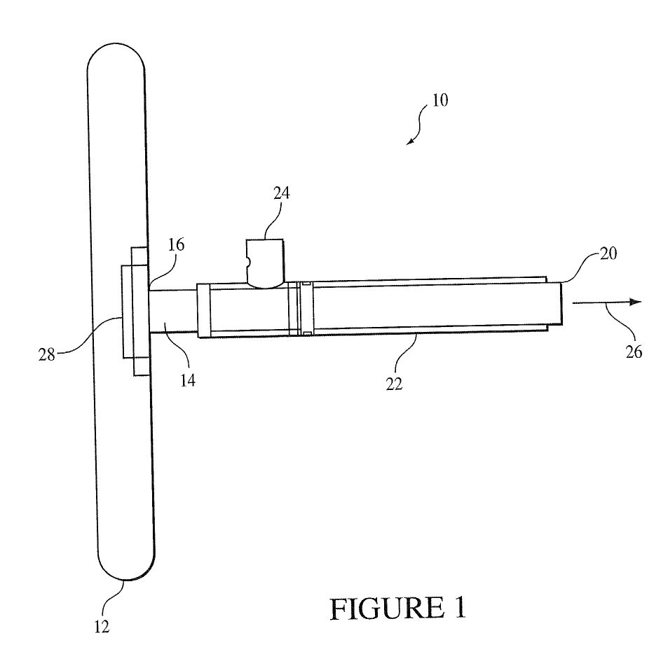

Referring to the Figures and particularly to FIG. 1, a retractable steering system designated by reference numeral 10 is shown. Steering system 10 is operatively connected to a vehicle (not shown) to allow steering or controlling of the direction of travel of the vehicle by controlling the direction of steerable wheels (not shown). Steering system 10 presents a steering wheel 12 for control of the vehicle.

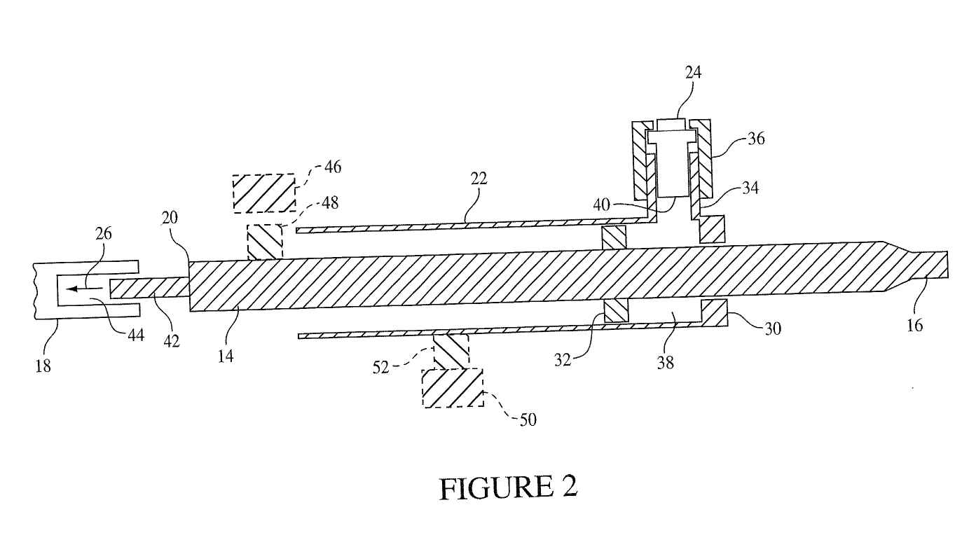

Steering wheel 12 is operatively connected to a steering column 14. More specifically, steering wheel 12 is connected to a first end 16 of steering column 14 such that rotation of the steering wheel rotates the steering column. Steering column 14 is also operatively connected to a steering box 18, shown schematically in FIGS. 2-5. Steering box 18 controls the wheels of the vehicle. Steering box 18 controls the wheels of the vehicle by a system such as, but not limited, to a rack and pinion system, an electrical assist system, or a drive by wire system. Steering column 14 is connected to steering box 18 at a second end 20 of the steering column such that rotation of the steering column activates the steering box. Thus, rotation of steering wheel 12 is translated by steering column 14 to steering box 18 for control of the vehicle.

Steering system 10 further includes an outer housing 22 including a gas generator 24. Outer housing 22 is fixedly secured to the vehicle. Steering column 14 is operatively disposed in outer housing 22 such that the steering column rotates within the outer housing. Similar to the operation of common air bag systems, gas generator 24 is adapted to receive a signal from a sensor 23 positioned to detect vehicle conditions, such as a sudden deceleration. Alternatively, sensor 23 provides a signal to a sensing and diagnostic module 25 or microcontroller adapted to receive and interpret a signal or plurality of signals for generating an activation signal to be received by gas generator 24.

Accordingly, a deployment command will be signaled by sensing and diagnostic module (SDM) 25 and sent to the initiator of the gas generator once the system determines that activation is required.

A propellant is ignited by a squib that fires in response to the signal received from the controller, the SDM receives signals (such as vehicle decelerations and impact sensors) in order to determine whether an activation signal is to be generated. In an alternative embodiment, one of the sensors is an electronic frontal sensor (EFS), which is an external sensor mounted in the engine compartment, typically on the radiator tie bar to supplement the internal sensors of the SDM in detecting and responding to threshold impacts. In addition, the SDM has its own internal sensors for measuring vehicle decelerations.

Accordingly, and if the appropriate signals from the sensors located throughout the vehicle are received, a signal for initiating the gas generator will be generated.

Upon receiving the signal, gas generator 24 provides a supply of gas to outer housing 22, which acts upon steering column 14 to retract the steering column in the direction of arrow 26. Accordingly, steering system 10, which includes steering wheel 12, steering column 14, outer housing 22 and gas generator 24, is adapted to retract the steering column in the direction of arrow 26 from a first position to a second position upon activation of gas generator 24.

Gas generator 24 is adapted to provide sufficient pressure to outer housing 22 to retract steering column 14. Accordingly, gas generator 24 may be of any conventional construction for generating gas to retract steering column 14. Conventional gas generators include stored gas inflators, pyrotechnic inflators, hybrid inflators, pressure cartridges, initiators or squibs and the like. Stored gas inflators have a pressure vessel containing stored pressurized gas in communication with the airbag through various types of rupturable outlets or diaphragms. Pyrotechnic inflators include a propellant, such as sodium azide and the like, that is ignited and the resultant gas flows through an outlet to the cushion. Hybrid or augmented inflators include both a pressure vessel containing stored pressurized gas and a pyrotechnic inflator. When the generator is ignited, the resultant gas flows with the stored gas to the cushion through the pressure vessel outlet. Initiators ignite pyrotechnic material, such as zirconium potassium perchlorate, that ruptures the outlets or diaphragms of stored gas inflators, ignites the propellant of pyrotechnic inflators, and opens the pressure vessel/ignites the pyrotechnic inflator of the hybrid inflators. By way of example, gas generator 24 is one of the following, including but not limited to: a stored gas inflator; a pyrotechnic inflator; a hybrid inflator; a pressure cartridge; an initiator; and equivalents thereof. Preferably, gas generator 24 is an initiator of the type used in any one of the aforementioned inflators or equivalents thereof.

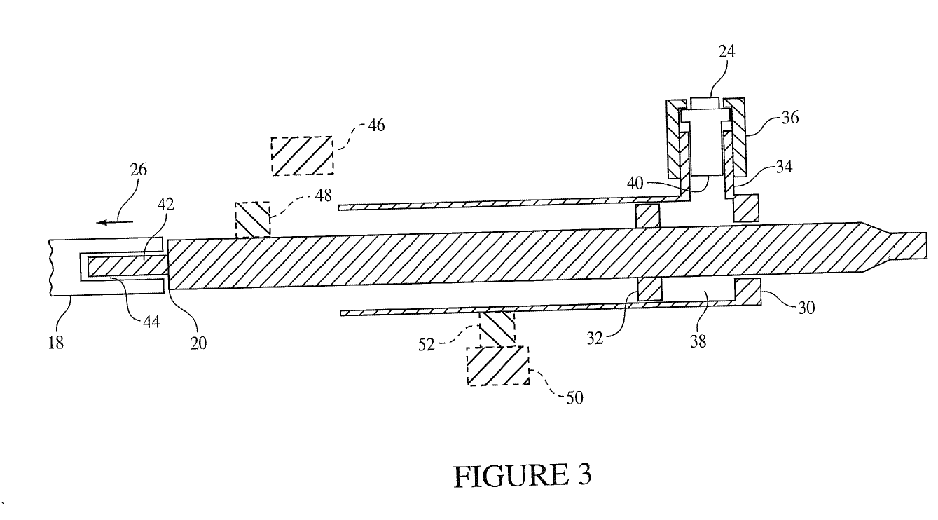

Referring to FIGS. 2 and 3, an exemplary embodiment of steering system 10 is shown. Steering wheel 12 has not been shown for purposes of clarity. Steering system 10 is illustrated in FIG. 2 in the first or use position, while FIG. 3 illustrates the steering system retracted in the direction of arrow 26. Outer housing 22 includes a front sealing member 30. Front sealing member 30 allows steering column 14 to rotate as described above, but also allows the steering column to retract in the direction indicated by arrow 26. Similarly, steering column 14 includes a rear-sealing member 32. Rear-sealing member 32, similar to front sealing member 30, allows steering column 14 to rotate as described above, butalso allows the steering column to retract in the direction indicated by arrow 26. Steering column 14 is disposed in outer housing 22 such that a sealed cavity 38 is formed between rear-sealing member 32 and front sealing member 30. Preferably, sealing members 32 and 30 are made of a sealing polymer having low friction characteristics such as, but not limited to, polytetrafloroethelene (PTFE) or Teflon and acetyl rubber.

Outer housing 22 also includes a radial member 34 and a cap portion 36 adapted to seal gas generator 24 therein. Preferably, radial member 34 threadably receives cap 36 to seal gas generator 24 in outer housing 22. Radial member 34 is in fluid communication with sealed cavity 38. Gas generator 24 includes one or more exit ports 40 disposed thereon for discharging gas therefrom. Gas generator 24 is sealed in radial member 34 such that exit ports 40 are directed toward and in fluid communication with sealed cavity 38. Accordingly, gas discharged from gas generator 24 acts to pressurize sealed cavity 38. The pressurized gas within sealed cavity 38 acts on rear sealing member 32 of steering column 14 to retract the steering column in the direction of arrow 26.

As discussed above, second end 20 of steering column 14 is operatively connected to steering box 18. Preferably, second end 20 includes a splined shaft 42 and steering box 18 includes a splined bore 44 corresponding to the splined shaft. Shown in FIG. 2, splined shaft 42 is inserted into splined bore 44 so as to transmit rotational forces imparted on steering column 14 by action on steering wheel 12. As shown in FIG. 3, splined bore 44 is adapted to further receive splined shaft 42 upon the retraction of steering column 14. Thus, steering column 14 remains operatively connected to steering box 18 in both the first or use position of FIG. 2 and the second or retracted position of FIG. 3. Accordingly, the gas discharged from gas generator 24 provides sufficient pressure to sealed cavity 3 8 such that splined shaft 42 is slidin splined bore 44 from the first or use position to the second or retracted position.

As an alternative embodiment and as illustrated by the dashed lines in FIGS. 2 and 3, steering column 14 is connected to a frame member 46 of the vehicle by a break away connection 48. Connection 48 allows for rotation of steering column 14 as described above and is adapted to prevent the steering column from retracting under normal use, but allows gas generator 24 to retract the steering column. Thus, connection 48 is a breakaway connection that is adapted to prevent retraction under forces in the direction of arrow 26 incurred by normal use of steering column 14, but releases or breaks away under the forces imparted to the steering column by gas generator 24.

Shown in FIG. 2, connection 48 is secured to frame 46 in the first or use position. However, as shown in FIG. 3, at least a portion of connection 48 has been released from frame 46 as a result of the forces imparted on steering column 14 by gas generator 24. It should be recognized that connection 48 is described above by way of example and that other connections, which allow steering column 14 to breakaway from frame 46 under the forces imparted to the steering column by gas generator 24, are considered within the scope of the present invention.

In yet another alternate embodiment and as shown by the dashed lines in FIGS. 2 and 3, outer housing 22 is connected to a frame member 50 of the vehicle by a second break away connection 52. Connection 52 allows for rotation of steering column 14 within outer housing 22 as described above. Connection 52 is adapted to prevent outer housing 22 from retracting under either normal use or under the forces imparted to steering column 14 by gas generator 24. Thus, during normal use and during the retraction of steering column 14, outer housing 22 remains stationary due to connection 52.

However, connection 52 is also adapted to release or break away from frame member 50. In other words, connection 52 is also a break away connection that is adapted to release or break away under forces greater than those generated by gas generator 24. Here, connection 52 requires a larger break away force than is required to release connection 48. Connection 52 is contemplated for use with connector 48 or as an alternative to connector 48. It should be recognized that connection 52 is described by way of example and that other connections that allow outer housing 22 to breakaway from frame 50 are considered within the scope of the present invention.

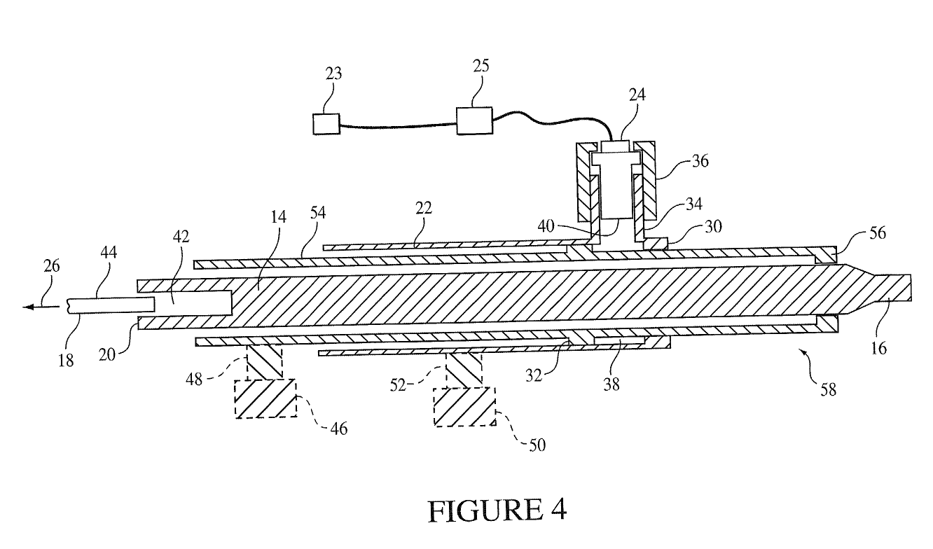

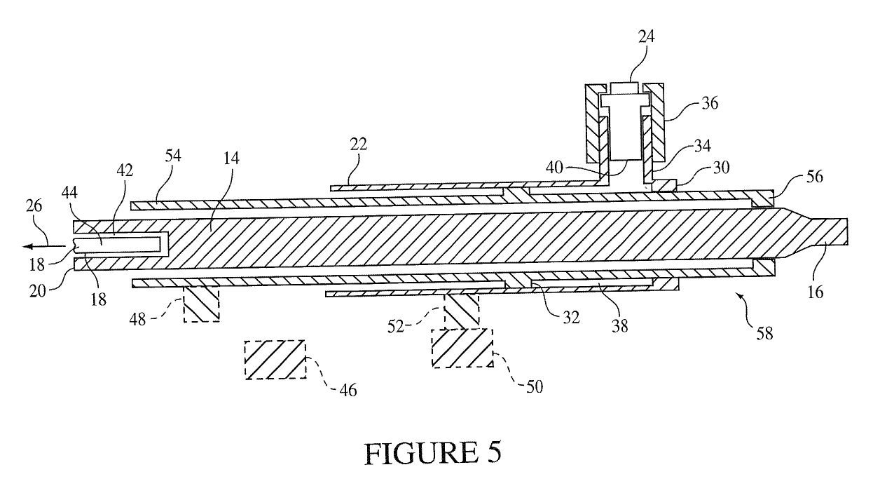

Referring now to FIGS. 4 and 5, an alternate exemplary embodiment of steering system 10 is shown. Again, steering wheel 12 has not been shown for purposes of clarity. FIG. 4 shows steering system 10 in its first or use position. FIG. 5 shows steering system 10 retracted in the direction of arrow 26.

Steering column 14 is housed in an inner tube 54. Inner tube 54 has a front bearing member 56 adapted to allow rotation of steering column 14 and adapted to prevent extension or retraction of the steering column with respect to the inner tube. Inner tube 54, front bearing member 56 and steering column 14 form an assembly 58.

Outer housing 22 includes a front sealing member 30. Front sealing member 30 allows assembly 58 to retract in the direction indicated by arrow 26, but resists rotation of the assembly with respect to outer tube 22. Inner tube 54 includes a rear-sealing member 32. Rear-sealing member 32, similar to front sealing member 30, allows inner tube 54 to retract in the direction indicated by arrow 26, but resists rotation of the inner tube with respect to outer tube 22. Inner tube 54 is disposed in outer housing 22 such that a sealed cavity 38 is formed between rear-sealing member 32 and front sealing member 30. Preferably, sealing members 32 and 30 are made of a sealing polymer having low friction characteristics such as, but not limited to, PTFE or Teflon and acetyl rubber. Accordingly, steering column 14 is adapted to rotate with respect to inner tube 54 and assembly 58 is adapted to retract with respect to outer housing 22.

Outer housing 22 also includes a radial member 34 and a cap portion 36 adapted to seal gas generator 24 therein. Preferably, radial member 34 threadably receives cap 36 to seal gas generator 24 in outer housing 22. Radial member 34 is in fluid communication with sealed cavity 38. Gas generator 24 includes one or more exit ports 40 disposed thereon for discharging gas therefrom. Gas generator 24 is sealed in radial member 34 such that exit ports 40 are directed toward and in fluid communication with sealed cavity 38. Accordingly, gas discharged from gas generator 24 acts to pressurize sealed cavity 38. The pressurized gas in sealed cavity 38 acts on rear-sealing member 32 of inner tube 54 to retract assembly 58 in the direction of arrow 26.

As discussed above, second end 20 of steering column 14 is operatively connected to steering box 18. Second end 20 includes a splined bore 38 and steering box 18 includes a splined shaft 44 corresponding to the splined bore. Shown in FIG. 4, splined bore 38 receives splined shaft 44 so as to transmit rotational forces imparted on steering column 14 by the occupant's action on steering wheel 12. As shown in FIG. 5, splined bore 38 is adapted to further receive splined shaft 44 upon the retraction of inner tube 54 and steering column 14. Thus, steering column 14 remains operatively connected to steering box 18 in both the first position of FIG. 4 and the second position of FIG. 5. Accordingly, the gas discharged from gas generator 24 provides sufficient pressure to sealed cavity 38 such that splined shaft 44 is slid in splined bore 38 from the first or use position to the second or retracted position.

In an alternate embodiment and as illustrated by the dashed lines in FIGS. 4 and 5, inner tube 54 is connected to frame member 46 of the vehicle by connection 48. Connection 48 is adapted to prevent rotation and retraction of assembly 58 with respect to outer housing 22 under normal use, but allows retraction of the assembly upon the forces imparted to the assembly by gas generator 24. Thus, connection 48 is a breakaway connection that is adapted to prevent retraction under forces in the direction of arrow 26 incurred by normal use of steering column 14, but releases or breaks away under the forces imparted to inner tube 54 by gas generator 24. Shown in FIG. 4, connection 48 is secured to frame 46. However, as shown in FIG. 5, at least a portion of connection 48 has been released from frame 46 as a result of the forces imparted on inner tube 54 by gas generator 24.

In yet another alternate embodiment shown in FIGS. 4 and 5, outer housing 22 is connected to frame member 50 of the vehicle by connection 52. Connection 52 is adapted to prevent outer housing 22 from retracting under either normal use or under the forces imparted to assembly 58 by gas generator 24. Thus during normal use and during the retraction of assembly 58, outer housing 22 remains stationary due to connection 52. However, connection 52 is adapted to release or break away from frame member 50 in the event that the occupant interacts with outer housing 22. In other words, connection 52 is also a breakaway connection that is adapted to release or break away due to forces imparted to outer housing 22. However, connection 52 requires a larger break away force than is required to release connection 48.

It should be recognized that steering column 14 is described by way of example as being connected to steering box 18 at a second end 20 by means of a splined shaft and bore connection. However, other connections between steering column 14 and steering box 18 are considered within the scope of the present invention provided that such connection transmits the rotation forces imparted on the steering column to the steering box at least in the first or use position and allows for the steering column to be retracted by the force imparted by gas generator 24.

The stroke or amount of retraction of steering column 14 by steering system 10 is normally limited by the interference of steering wheel 12 and the interior of the vehicle. System 10 preferably retracts steering column 14 in a range from about ½ inch to about 5 inches.

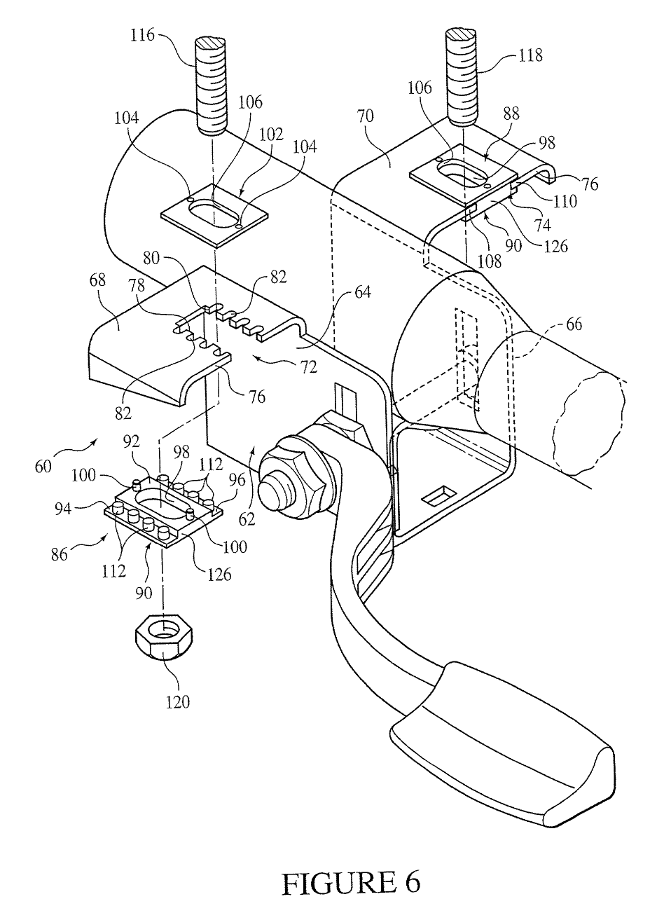

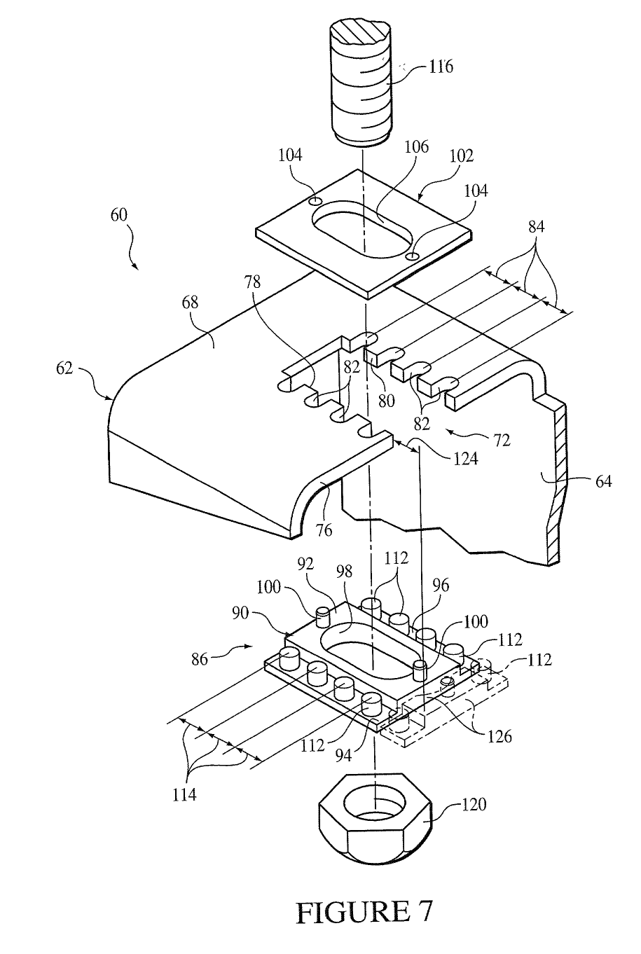

Referring now to FIGS. 6 and 7, an exemplary embodiment of breakaway connection 48 and/or 52 is shown and is designated by reference numeral 60. Connection 60 includes a mounting bracket 62 having a pair of vertical sides 64 and 66 on opposite sides of a steering system and a pair of lateral flanges 68 and 70 extending in opposite directions from respective ones of the vertical sides 64 and 66.

Connection 60 further includes a pair of slots 72 and 74 in respective ones of the lateral flanges 68 and 70 each open toward steering wheel 12 through an edge 76 of the corresponding one of the lateral flanges. Each open slot 72 and 74 has a pair of side edges 78 and 80 parallel to the longitudinal centerline of the steering system. Each of the side edges 78 and 80 is interrupted by a plurality of notches 82 separated from each other by equal linear pitch dimensions 84 in the direction of the longitudinal centerline of the steering system.

A pair of identical capsules 86 and 88 are disposed in respective ones of the open slots 72 and 74. A capsule base 90 of each capsule 86 and 88 has a planar top surface 92, a pair of linear shoulders 94 and 96 along respective ones of a pair of side edges of the capsule base, an aperture 98 elongated parallel to the linear shoulders 94 and 96, and a pair of studs 100 perpendicular to the planar top surface 92.

A flat capsule cover 102 of each capsule 86 and 88 has a pair of sockets 104 therein for receiving respective ones of the studs 100 and an elongated aperture 106 matching the elongated aperture 98 in the capsule base. The capsule cover 102 overhangs each of the linear shoulders 94 and 96 on the capsule base 90 and cooperates therewith in defining a pair of C-shaped side channels 108 and 110 on the capsule in which the side edges 78 and 80 of the corresponding one of the open slots 72 and 74 are captured perpendicular to the lateral flanges 68 and 70. The depth of the side channels 108 and 110 corresponds to the thickness of the lateral flanges 68 and 70 to minimize vertical lash between the capsules 86 and 88 and bracket 62.

A plurality of shear pins 112 are rigidly attached to the capsule base 90 in each of the side channels 108 and 110 of the capsule perpendicular to the linear shoulders 94 and 96. The shear pins 112 are preferably molded integrally with the capsule base where the latter is constructed from a plastic such as nylon or they may be molded separately and rigidly attached to the capsule base by conventional techniques.

Shear pins 112 are separated from each other by equal linear pitch dimensions 114 in the direction of the linear shoulders 94 and 96. The linear pitch dimensions 114 are equal to the linear pitch dimensions 84 between the notches in the side edges 78 and 80 of the open slots 72 and 74. The height of shear pins 112 above the linear shoulders 94 and 96 corresponds to the depth of the side channels 108 and 110.

The capsule bases 90 are installed in corresponding ones of the open slots 72 and 74 from below the lateral flanges 68 and 70 separately from the capsule covers 102 with the shear pins 112 being lodged in respective ones of the notches 82 in the side edges 78 and 80 of the open slots. The capsule covers 102 seat on the top surfaces 92 of the capsule bases from above the lateral flanges with the studs 100 being received in the sockets 104 and with the elongated apertures 106 in register with the elongated apertures 98 in the capsule bases. The capsule covers may be retained by fasteners, not shown, on the studs 100 or by staking, heading or otherwise expanding the studs behind the capsule covers. The shear pins 112 substantially fill the notches 82 to minimize lash in the plane of the lateral flanges 68 and 70 between the capsules 86 and 88 and the bracket 62.

A pair of vertical hangers 116 and 118 rigidly attached to the vehicle (not shown) protrude down through the aligned elongated apertures 98 and 106 in corresponding ones of the capsules 86 and 88. The capsules are rigidly and permanently clamped to the vehicle by respective ones of a pair of fasteners 120 and 122 on the hangers 116 and 118 below the capsules. The hangers 116 and 118 cooperate with the capsules 86 and 88 in supporting system 10 with substantially zero lash perpendicular to the lateral flanges 68 and 70 and in the plane of the lateral flanges.

Operation of connection 60 is described below with respect to retraction of system 10. Here and particularly referring to connector 48, the force imparted by gas generator 24 on system 10 reacts on connection 60 to break away the connection allowing the system to retract. The force urges the lateral flanges 68 and 70 to slide out of the side channels 108 and 110 of the capsules 86 and 88 in the direction of the longitudinal centerline of system 10 but is resisted by the shear pins 112 in the notches 82. The resistance afforded by the pins 112 is sustained until the force attains a magnitude sufficient to fracture concurrently all of the pins 112, whereupon the bracket 62 is released from the capsules 86 and 88 and slides out of the side channels 108 and 110 concurrent the retraction of system 10.

The equal linear pitch dimensions 84 and 114 between the notches 82 and between the shear pins 112 permits the magnitude of the force required to initiate release of the outboard mounting bracket 62 from the vehicle body to be adjusted for different motor vehicle applications. More particularly, the magnitude of the force required to initiate release of the bracket 62 from the vehicle is the sum of the forces required to fracture separately each of the shear pins 112 lodged in the notches 82 and is, therefore, directly proportional to the number of shear pins on each capsule that are lodged in the notches. Because the linear pitch dimensions 84 and 114 are equal, the number of shear pins 112 on each capsule that are lodged in the notches 82 can be varied simply by varying the magnitude of the longitudinal overlap between the capsules 86 and 88 and the open slots 72 and 74 as represented by a dimension 124 between the edge 76 of the corresponding lateral flange 68 and 70 and an end 126 of each capsule base 90.

For example, the dimension 124 is zero when the capsules 86 and 88 completely fill the open slots 72 and 74. In that circumstance, the maximum number of shear pins 112 on the capsules are lodged in the notches 82 in the lateral flanges 68 and 70 and the magnitude of the force required to initiate release of the bracket 62 from the vehicle is, accordingly, also maximum. As the dimension 124 increases from zero in increments equal to the linear pitch dimensions 84 and 114 as schematically represented in broken lines in FIG. 4, the number of shear pins 112 on each of the capsules lodged in the notches 82 decreases by two for each incremental step so that the magnitude of the force required to initiate release of the bracket 62 from the vehicle incrementally decreases. The elongated apertures 98 and 74 in the capsule bodies and in the capsule covers are, of course, be long enough to avoid interference between the vertical hangers 116 and 118 and the ends of the apertures as the dimension 124 increases.

It should be recognized that connection 60 is described above by way of example only. Of course, and as applications require, other connections 60 adapted to break away are considered within the scope of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A retractable steering column, comprising:
a steering column;
an outer tube having a first sealing member;
a second sealing member on said steering column;
a cavity formed by sealing said steering column in said outer tube by said first sealing member and said second sealing member; and
means for generating a retraction pressure in said cavity, said steering column being rotatable with respect to said outer tube, and said steering column being slideable with respect to said outer tube from a first position to a second position upon the generation of said retraction pressure in said cavity.

2. The retractable steering column of claim 1, wherein said second position retracts said steering column in a range from about ½ inch to about 5 inches from said first position.

3. The retractable steering column of claim 1, wherein said second position retracts said steering column until a steering wheel disposable on said steering column interferes with an interior surface of a vehicle in which the retractable steering column is installed.

4. The retractable steering column of claim 1, further comprising:
a splined connection on a lower end of said steering column, said splined connection being securable to a matching splined connection of a steering box of a vehicle, and said splined connection being slideable with respect to said matching splined connection between said first position and said second position.

5. The retractable steering column of claim 1, further comprising:
a first breakaway connection included on said steering column, said first breakaway connection being connectable to a vehicle and being releasable by a first release pressure lower than said retraction pressure.

6. The retractable steering column of claim 5, further comprising:
a second breakaway connection included on said outer tube, said second breakaway connection being connectable to said vehicle and being releasable by a second release pressure higher than said retraction pressure.

7. The retractable steering column of claim 1, wherein said first sealing member and said second sealing member each include a low friction polymer seal.

8. The retractable steering column of claim 1, wherein said means for generating said retraction pressure is selected from the group consisting of stored gas inflators, pyrotechnic inflators, hybrid inflators, pressure cartridges, and initiators.

9. A steering system for use with a vehicle, comprising:
an outer tube having a first sealing member, said outer tube being securable to the vehicle;
a steering column having a lower end and an upper end, said lower end being securable to a steering box of the vehicle, said upper end being securable to a steering wheel;
a second sealing member disposed on said steering column between said lower end and said upper end, said steering column being rotatably sealed in said outer tube by said first sealing member and said second sealing member;
a cavity defined between said outer tube and said steering column by said first sealing member and said second sealing member; and
means for generating a retraction pressure in said cavity and being activatable by an activation signal for generating said retraction pressure, said steering column being slideable with respect to said outer tube from a first position to a second position upon the generation of said retraction pressure.

10. The steering system of claim 9, further comprising a splined connection on said lower end of said steering column, said splined connection being securable to a matching splined connection of said steering box and being slideable with respect to said matching splined connection between said first position and said second position.

11. The steering system of claim 9, further comprising a first breakaway connection included on said steering column, said first breakaway connection being connectable to the vehicle and being releasable by a first release pressure lower than said retraction pressure.

12. The steering system of claim 11, further comprising a second breakaway connection included on said outer tube, said second breakaway connection being connectable to the vehicle and being releasable by a second release pressure higher than said retraction pressure.

13. The steering system of claim 9, wherein said means for generating said retraction pressure is selected from the group consisting of stored gas inflators, pyrotechnic inflators, hybrid inflators, pressure cartridges, and initiators.

14. A retractable steering system for use with a vehicle having a steering box, a steering wheel and a means for generating and activation signal, comprising:
an outer tube having a first sealing member and a first breakaway connection for securing said outer tube to the vehicle;
an inner tube having a bearing member, a second sealing member, and a second breakaway connection for securing said inner tube to the vehicle;
a cavity formed by said first sealing member and said second sealing member, said first sealing member and said second sealing member slidably sealing said inner tube in said outer tube;
a steering column having a lower end securable to the steering box, and an upper end securable to the steering wheel; and
a gas generator for generating a retraction pressure in said cavity in response to the activation signal, said steering column being rotatably secured by said bearing member in said inner tube, and said inner tube being slideable with respect to said outer tube from a first position to a second position upon the generation of said retraction pressure.

15. The retractable steering system of claim 14, wherein said second position retracts said gas retractable steering column by about five inches from said first position.

16. The retractable steering system of claim 14, wherein said second position retracts said gas retractable steering column until said steering wheel interferes with an interior surface of the vehicle.

17. The retractable steering system of claim 14, further comprising:
a splined connection on said lower end of said steering column, said splined connection being securable to a matching splined connection of the steering box and being slideable with respect to said matching splined connection between said first position and said second position.

18. The retractable steering system of claim 14, wherein said first breakaway connection is releasable by a first release pressure and said second breakaway connection is releasable by a second release pressure.

19. The retractable steering system of claim 18, wherein said retraction pressure is greater than said first release pressure and said second release pressure is greater than said first release pressure.

20. A method for automatically retracting a steering column in a vehicle, comprising:
initiating a retraction signal;
generating gas in response to said retraction signal to generate a retracting pressure in a sealed cavity between said steering column and an outer tube; and
sliding said steering column with respect to said outer tube from a first position to a second position in response to said retracting pressure acting on said steering column.

21. The method for automatically retracting a steering column of claim 20, further comprising releasing a first breakaway connection securing said steering column to the vehicle in response to said retracting pressure.

22. The method for automatically retracting a steering column of claim 21, further comprising releasing a second breakaway connection securing said outer tube to the vehicle at a pressure greater than said retracting pressure.

23. The method for automatically retracting a steering column of claim 20, further comprising sliding a splined connection of said steering column with respect to a matching splined connection of a steering box from said first position to said second position.
